(19) United States
(12) Patent Application Publication
(10) Pub. No.: US 2026/0266229 A1
(43) Pub. Date: Sep. 10, 2026

(54) SYSTEMS AND METHODS FOR PROGNOSTICS FOR HEALTH PREDICTION OF AIR HANDLING VALVE-ACTUATOR WITH POSITION SENSING

(71) Applicant: Cummins Inc., Columbus, IN (US)

(72) Inventors: Chandan Nene, Columbus, IN (US); Daniel E. Boewe, Columbus, IN (US); Pradheepram Ottikkutti, Erie, PA (US)

(73) Assignee: Cummins Inc., Columbus, IN (US)

(21) Appl. No.: 18/993,507

(22) PCT Filed: Jul. 11, 2023
(86) PCT No.: PCT/US2023/027409

§ 371 Date: Jan. 10, 2025

(30) Foreign Application Priority Data
Jul. 12, 2022 (IN) 202241039990

(51) Int. Cl. F02D 9/04; F02D 41/22

(52) U.S. Cl. CPC F02D 9/04; F02D 41/221

(57) ABSTRACT

A system includes a position-controlled valve and at least one processing circuit. The at least one processing circuit is configured to: determine one or more estimated operational parameters for the position-controlled valve based on a model; retrieve one or more reference parameters for the position-controlled valve; determine a margin of error between the one or more estimated operational parameters and the one or more reference parameters; determine a trend regarding the margin of error; predict a fault in response to the trend regarding the margin of error; and, control operation of the position-controlled valve in response to predicting the fault.

### CROSS-REFERENCE TO RELATED APPLICATION

This P.C.T. patent application claims priority to Indian Patent Application number 202241039990, filed Jul. 12, 2022, which is incorporated herein by reference in its entirety.

### TECHNICAL FIELD

The present disclosure relates to diagnostics for internal combustion engine systems and, more particularly, to diagnostics and prognostics for air handling valves.

### BACKGROUND

Internal combustion engines can be used in several applications, such as in buses, trucks, and so on. Internal combustion engines may include or be coupled to an exhaust throttle valve (ETV) which is configured to control the flow of exhaust gas from the internal combustion engine. The ETV, however, may be subject to thermal stresses by being positioned in the flow of exhaust gas. This may cause sub-par behavior in the system in terms of increased frictional resistance and/or motor degradation over time as well as undesired emissions from the system.

### SUMMARY

Systems and methods for diagnosing position-controlled valves are provided. One embodiment relates to a system including a position-controlled valve and at least one processing circuit coupled to the position-controlled valve. The at least one processing circuit is configured to: determine one or more estimated operational parameters for the position-controlled valve based on a model; retrieve one or more reference parameters for the position-controlled valve; determine a margin of error between the one or more estimated operational parameters and the one or more reference parameters; determine a trend regarding the margin of error; predict a fault in response to the trend regarding the margin of error; and control operation of the position-controlled valve in response to predicting the fault. In one embodiment, the position-controlled valve is an exhaust throttle valve. In one embodiment, controlling the operation of the position-controlled valve includes increasing a frequency of selectively opening or closing, at least partially, the position-controlled valve. In one embodiment, controlling the operation of the position-controlled valve includes generating and providing a message regarding the position-controlled valve. In one embodiment, the at least one processor is further configured to determine if a qualified event has occurred and in response to determining that the qualified event has occurred, retrieve the one or more reference parameters for the position-controlled valve. In one embodiment, the qualified event is at least one of opening the position-controlled valve, closing the position-controlled valve, or determining an auto zero offset.

Another embodiment relates to a method for controlling operation of a position-controlled valve. The method includes: receiving one or more estimated operational parameters for the position-controlled valve based on a model; retrieving one or more reference parameters for the position-controlled valve; receiving a margin of error between the one or more estimated operational parameters and the one or more reference parameters; receiving a trend regarding the margin of error; predicting a fault in response to the trend regarding the margin of error; and controlling operation of the position-controlled valve in response to predicting the fault. In one embodiment, the position-controlled valve is an exhaust throttle valve. In one embodiment, controlling the operation of the position-controlled valve includes increasing a frequency of selectively opening or closing, at least partially, the position-controlled valve. In one embodiment, controlling the operation of the position-controlled valve includes generating and providing a message regarding the position-controlled valve. In one embodiment, the method further includes determining that the trend regarding the margin of error indicates an increasing margin of error and determining the fault associated with the position-controlled valve. In one embodiment, the method further includes determining that the trend regarding the margin of error indicates a steady or decreasing margin of error and determining no fault associated with the position-controlled valve.

Still another embodiment relates to a non-transitory computer-readable media storing instructions therein that, when executed by at least one processor, causes the at least one processor to perform operations. The operations include: determining one or more estimated operational parameters for the position-controlled valve based on a model; retrieving one or more reference parameters for the position-controlled valve; determining a margin of error between the one or more estimated operational parameters and the one or more reference parameters; determining a trend regarding the margin of error; predicting a fault in response to the trend regarding the margin of error; and controlling operation of the position-controlled valve in response to predicting the fault. In one embodiment, the position-controlled valve is an exhaust throttle valve. In one embodiment, controlling the operation of the position-controlled valve includes increasing a frequency of selectively opening or closing, at least partially, the position-controlled valve. In one embodiment, controlling the operation of the position-controlled valve includes generating and providing a message regarding the position-controlled valve. In one embodiment, the threshold parameter is one of a healthy threshold parameter or an unhealthy threshold parameter. In one embodiment, surpassing the healthy threshold parameter indicates a healthy position-controlled valve and surpassing the unhealthy threshold parameter indicates a faulty position-controlled valve.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a position-controlled valve fault prediction system, according to an exemplary embodiment.

FIGS. 2A, 2B, and 2C are ETVs, according to an exemplary embodiment.

FIG. 3 is a block diagram of a controller of the system of FIG. 1, according to an exemplary embodiment.

FIG. 4 is a flow diagram of a method for detecting and predicting a health of a valve in an engine system and, particular an exhaust throttle valve, according to an exemplary embodiment.

FIGS. 5-6 are graph diagrams of comparison graphs between healthy and unhealthy threshold parameters, according to an exemplary embodiment.

### DETAILED DESCRIPTION

Following below are more detailed descriptions of various concepts related to, and embodiments of, air handling valves, and particularly exhaust throttle valves, and methods of diagnosing and operating the throttle valves. The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, systems and methods for detecting and predicting a health of a position-controlled valve (i.e., predicting faults) of air handling valves (e.g., exhaust throttle valve, exhaust gas recirculation valve (EGR), idle air control valve, and/or other position-controlled valve) are disclosed according to various embodiments herein. An air handling valve may include an exhaust throttle valve (ETV) which is used as an exemplary embodiment throughout the present disclosure. However, it should be noted that the systems and methods described herein may apply to other actuator-controlled valve with a position feedback (i.e., a position-controlled valve). The ETV may be positioned downstream of an engine. The ETV is configured to receive exhaust gas and control the flow of exhaust gas through a system coupled to an engine (e.g., a vehicle). As the ETV is exposed to thermal stress, the performance/health of the ETV may degrade over time leading to a variety of faults including closure faults.

A health of an air handling valve actuator with position sensing may include position-controlled valve faults, which refer to when an actual position of a position-controlled valve (e.g., an ETV) is different from commanded position of the position-controlled valve. As a particular example, an ETV may be commanded to a fully closed position (e.g., 100% nominal closure or 0% nominal opening). Given assembly, sensor, and operation variations, a sensor reading taken during a qualified event such as an auto closure event which indicates a full closure may be close but not exactly 100% nominal closure. For example, an actual closure may be between 95% and 99%. This offset between the nominal closure amount and the actual closure amount may be known as an auto zero value. When calculating the auto zero value, the position-controlled valve may be in a controlled environment (e.g., no fluid flow, the engine is stopped, no side loading, etc.). However, in some embodiments, the auto zero value may be determined at any time during the operation of the valve. This auto zero value may be used to correct the sensor reading so that system interprets the actual closure amount (e.g., 95%-99%) as a full closure even though it is not closed 100%. In some embodiments, the auto zero offset computation involves fully spanning the valve and determining when the valve reaches a physical end stop within a predetermined time and a predetermined actuator effort. Given the difference between commanded and actual positions, over time, the ETV may experience degradation leading to position-controlled valve faults. In some embodiments, a position-controlled valve fault may occur if the ETV is unable to achieve a fully closed position which is indicated by the auto zero value being above a certain threshold. As another example, a position-controlled valve fault may occur if the ETV is unable to achieve an end stop position within predetermined time and/or using a predetermined amount of effort by an actuator. Determining a position-controlled valve fault may occur during a qualified event.

Failure to compute an accurate auto zero value results in an incorrect setting of the position of the ETV. An inability to reliably control the position of the ETV may lead to many undesirable effects including, but not limited to, decreasing the temperature of the aftertreatment system which may lead to a decreased NOx conversion efficiency, increased PM emissions, and so on. In this regard, the ETV may be commanded to close, at least partially, to increase the pressure which increases the temperature to assist with thermal management (e.g., getting and maintain aftertreatment components at desired operating temperatures). If control of the ETV is unpredictable, an inability to restrict the flow of exhaust gas may be realized which may lead to an inability to increase temperatures and a reduction in thermal management. Therefore, systems and methods, as described herein, for detecting and predicting position-controlled valve faults of air handling valve-actuator's position offset may be desirable.

As described herein, a “qualified event” refers to any event in which the valve moves a predefined amount (e.g., auto closure events, opening events, etc.). The predefined amount indicates that the movement is more than a steady-state movement (e.g., a movement beyond a predefined amount such as fifteen percent movement). The qualified event may, therefore, occur during transient events, such as during thermal management commands or operating modes, transient vehicle operations (e.g., hill descents/climbs, etc.), and various other transient conditions.

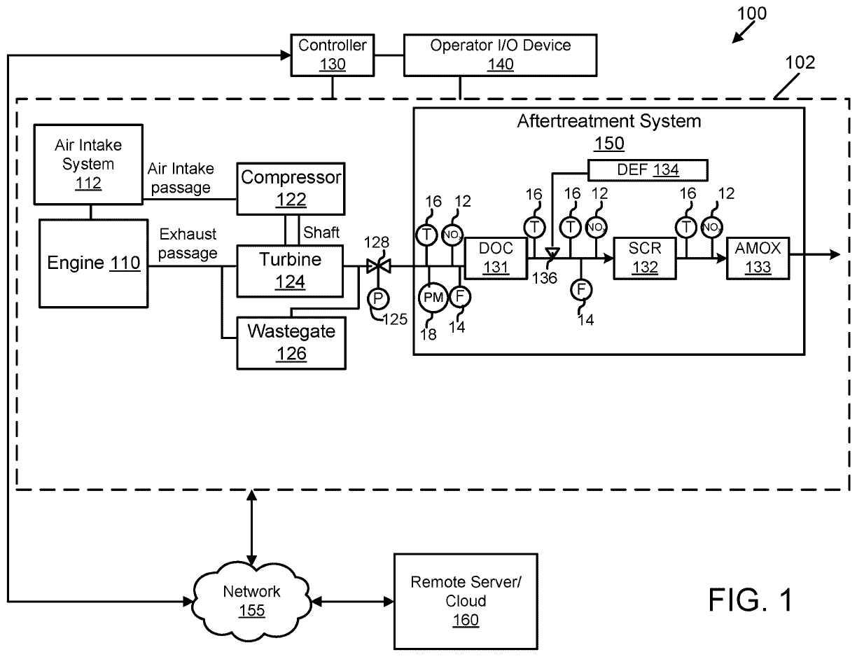

Referring now to FIG. 1, a schematic block diagram of a position-controlled valve fault prediction system 100 is shown, according to an example embodiment. The position-controlled valve fault prediction system 100 includes a vehicle 102 which is coupled to a remote server/cloud 160 through a network 155. As shown in FIG. 1, the vehicle 102 includes an engine 110, a turbocharger that is shown to include a compressor 122 and a turbine 124, an exhaust aftertreatment system 150 fluidly coupled to the engine 110, an operator input/output device 140, and a controller 130 communicably and operatively coupled to the components in FIG. 1. While the controller 130 and operator I/O device 140 are positioned outside of the vehicle 102 box, this is for clarity to show coupling of these components to various components within the vehicle. The controller 130 and I/O device 140 are a part of the vehicle 102. The vehicle 102 may be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle (e.g., mining equipment, etc.). In some embodiments, the vehicle 102 may be configured as a stationary piece of equipment, such as a generator or genset.

Briefly, in the vehicle 102, the engine 110 is charged with airflow by a compressor 122. The airflow mixes with fuel supplied from a fuel source. Combustion takes place in the engine 110. Exhaust gas from combustion is discharged to a turbine 124, which is mechanically coupled to the compressor 122 and drives the compressor 122. A wastegate 126 can enable part of the exhaust gas to bypass the turbine 124 and directly enter the aftertreatment system 150, resulting in less power transfer to the compressor 122. In some embodiments, the turbine 124 may be fluidly coupled to an ETV 128. The turbine flow enters the aftertreatment system 150 through the ETV 128 for aftertreatment before releasing the exhaust gas to the atmosphere.

The engine 110 may be any internal combustion engine (e.g., compression-ignition, spark-ignition) powered by any fuel type (e.g., diesel, ethanol, gasoline, etc.). An example of diesel engine is shown in FIG. 1 for illustration only and not for limitation. The engine is coupled to an air intake system 112. Other components of the engine 110 are omitted from explanation herein, such that this description and depiction of the components is not meant to be limiting.

The intake air may first flow through an air cleaner (not shown in the present figure) disposed upstream of the compressor 122 and structured to purify the intake air. The compressor 122 may compress the cleaned air, thus increasing the temperature and pressure of the airflow. The compressed air may then be aspirated into the air intake system 112 of the engine 110 through an air intake passage. In some embodiments, a charge air cooler (not shown) is disposed in the air intake passage and structured to cool the air to increase the air density. In some embodiments, the air intake system 112 includes an air intake manifold, an air intake throttle, and/or an air intake valve structured to control access of the air to the one or more cylinders 114.

Burnt products of the combustion process (i.e., exhaust gas) may be discharged from the engine 110 and expelled into the turbine 124 through the exhaust passage. The turbine 124 is mechanically coupled to the compressor 122 through, for example, a shaft. As briefly mentioned above, the turbine, shaft, and compressor form a turbocharger. The exhaust gas discharged from the engine 110 may drive the turbine 124 to rotate, which may in turn drive the compressor to compress the air supplied to the engine 110. The wastegate 126 can enable part of the exhaust gas to bypass the turbine 124 and directly enter the aftertreatment system 150. As a result, less exhaust gas energy is available to the turbine 124, less power is transferred to the compressor 122, and the airflow is supplied to the engine 110 at a lower rate. Reducing a rate of the airflow at the same power level lowers the air to fuel ratio in the cylinder, which might result in an increase in the exhaust gas temperature. The wastegate 126 may be an open-close valve, or a full authority valve. In some embodiments, the wastegate 126 is integrated into the turbine 124. In some embodiments, the turbine 124 is a variable geometry turbine (VGT) with an adjustable inlet to control the flow of exhaust gas therethrough. When exhaust gas exits the turbine 124, the exhaust gas flows downstream to the ETV 128 and/or into the aftertreatment system 150.

The ETV 128 is structured to control the flow rate of the exhaust gas from the engine 110 and, particularly, from the turbine 124 from the engine 110. The ETV 128 may be a variety of types of valves, such as a butterfly valve or a poppet valve. The ETV 128 may include an actuator that is powered (e.g., electrically by a battery of the vehicle 102 or other power source) that is commanded by the controller 130 to move to various positions (full open, full close, and a variety of positions in between). Accordingly, the controller 130 may provide control signals to the actuator to control movement of the valve member of the ETV 128. The ETV may control the flow rate and/or pressure of a fluid stream, such as the exhaust gas stream. In turn, the temperature of the exhaust gas may be controlled, at least partly.

The ETV 128 may include a housing and a control surface that interacts with the exhaust gas to increase backpressure or decrease backpressure. The ETV 128 is communicatively coupled to the controller 130. The ETV 128 may be manipulated, actuated by, or otherwise controlled by the controller 130 (e.g., via an actuator, not shown, coupled to the ETV and to the controller 130). In some embodiments, the ETV 128 may located in different locations within the vehicle 102. For example, in the exemplary embodiment shown in FIG. 1, the ETV 128 is located upstream of the aftertreatment system. In other embodiments, the ETV 128 may be positioned within the aftertreatment system 150 (e.g., upstream of the DOC, between the DOC and the SCR, etc.), downstream of the aftertreatment system 150, or in another position. In still some embodiments, the system may include only one ETV while in other embodiments, the vehicle may include more than one ETV 128. In some embodiments, the ETV 128 may be coupled to an ETV position sensor 125 which is configured to measure a position of one or more components of ETV 128 (e.g., ETV disk, etc.). As such and with the sensor 125 which provides position sensing, the ETV 128 is a type of air handling valve actuator.

In operation, the ETV 128 may be subject to high temperatures from the exhaust gas. The thermal stress placed on the ETV 128 may cause the ETV 128 to degrade over time leading to a variety ETV faults (e.g., ETV position faults, etc.). As explained above, current methods of monitoring ETVs and detecting ETV faults do not determine the margin of error between the current operation of the ETV 128 and one or more threshold operational or reference parameters. However, as described herein, the controller 130 is structured to detect ETV faults based on a margin of error between current operation (i.e., the current operational parameters of the ETV) of the ETV 128 and predetermined threshold parameters regarding ETV operation. In one embodiment, the predetermined threshold parameters may be determined based on a mathematical model, or model structure, for the ETV. The predetermined threshold or reference parameters may be previously determined and stored in the memory of the controller 130. The controller 130 may be configured to dynamically determine the current operational parameters of the ETV by analyzing the response of the ETV during one or more qualified events (e.g., a closure event) for the position-controlled valve based on a model structure.

The network 155 may be any type of communication protocol or network that facilitates the exchange of information between and among the vehicle 102 and the remote server 160. In one embodiment, the network 155 may be configured as a wireless network. The wireless network may be any type of wireless network, such as Wi-Fi, WiMAX, Internet, Radio, Bluetooth, ZigBee, satellite, radio, Cellular, Global System for Mobile Communications (GSM), General Packet Radio Service (GPRS), Long Term Evolution (LTE), etc. In an alternate embodiment, the network 155 may be configured as a wired network or a combination of wired and wireless protocol.

The remote computing system 160 is a remote computing system such as a remote server, a cloud computing system, and the like. Accordingly, “remote computing system” and “cloud computing system” are interchangeably used to refer to a computing or data processing system that has terminals distant from the central processing unit (e.g., the controller) from which users and/or other computing systems communicate with. In some embodiments, the remote computing system 160 is part of a larger computing system such as a multi-purpose server, or other multi-purpose computing system. In other embodiments, the remote computing system 160 is implemented on a third party computing device operated by a third party service provider (e.g., AWS, Azure, GCP, and/or other third party computing services).

The remote computing system 160 is operated by a product and/or service provider associated with the vehicle 102. Accordingly, in some embodiments, the remote computing system 160 is a service and/or system/component provider computing system and in turn controlled by, managed by, or otherwise associated with service provider, a system/component provider (e.g., an engine manufacturer, a vehicle manufacturer, an exhaust aftertreatment system manufacturer, etc.), and/or a fleet operator. In the example shown, the remote computing system 160 is operated and managed by an engine manufacturer (which may also manufacture and commercialize other goods and services). Accordingly, an employee or other operator associated with the service and/or system/component provider and/or the fleet operator may operate the remote computing system 160.

A combination of bypass flow and turbine flow may enter the aftertreatment system 150 for aftertreatment. In some embodiments, the bypass flow may enter aftertreatment system directly the turbine flow may enter the aftertreatment system through the ETV 128. The aftertreatment system 150 is structured to transform/reduce the environmentally harmful emissions from the engine 110, including for example, carbon monoxide, NOx, hydrocarbons, and/or soot. As shown and in exhaust gas flow direction, the aftertreatment system 150 includes a diesel oxidation catalyst (DOC), a selective catalytic reduction device 132, and an ammonia oxidation catalyst/device (133). Exhaust gas flowing through the AMOx catalyst 133 may be emitted to the environment or provided to another component before eventual emission to the environment. The aftertreatment system 150 further includes a reductant delivery system that has a diesel exhaust fluid (DEF) source 134 that supplies DEF (or other another reductant) to a DEF doser 136 via a DEF line. It should be understood that the depicted catalytic device(s)/components are not meant to be limiting as the present disclosure contemplates the inclusion of various other catalytic device(s)/components as well including, but not limited to, a three-way catalyst (TWC), a lean NOX trap (LNT), etc.

Additionally, the aftertreatment system 150 (as well as the remaining parts of the vehicle 102) may include one or more sensors (described below) that are real or virtual (i.e., not a physical sensor, but an algorithm, process, or method for determining a data value) that can be disposed in a variety of positions throughout the vehicle 102. The sensors are described below. Further, the aftertreatment system may include an exhaust gas recirculation loop as well. Thus, those of ordinary skill in the art will appreciate and recognize the high configurability of the exhaust aftertreatment system 150 of the present disclosure, with all such variations intended to fall within the scope of the present disclosure.

In some embodiments, the exhaust aftertreatment system 150 may include a particulate filter (not shown). In certain applications, a diesel particulate filter (DPF) is included in the system upstream of the DOC 131 and configured to trap or filter particulate matter in the exhaust.

Further and in one embodiment, which is in contrast to that shown in FIG. 1, the DOC 131 is excluded from the aftertreatment system 150 thereby leaving the DEF dosing system, SCR and AMOx devices. Additionally, the PM sensor 18 may also be excluded. Thus, those of ordinary skill in the art will appreciate and recognize the highly variable structural configuration of the aftertreatment system 130 with all such variations intended to fall within the scope of the present disclosure.

Components in the aftertreatment system can be arranged in any suitable manner. In the aftertreatment system 150 shown in FIG. 1, the DOC 131 is disposed upstream of the SCR device 132. Further, the reductant delivery device 136 is disposed between the DOC 131 and the SCR device 132. This depiction is not meant to be limiting as other types of arrangements are contemplated.

The DOC 131 may have any of various flow-through designs. Generally, the DOC 131 is structured to oxidize at least some particulate matter, e.g., the soluble organic fraction of soot, in the exhaust and reduce unburned hydrocarbons and CO in the exhaust to less environmentally harmful compounds. For example, the DOC 131 may be structured to reduce the hydrocarbon and CO concentrations in the exhaust to meet the requisite emissions standards for those components of the exhaust gas. DOC 131 may include, for example, palladium, platinum and/or aluminum oxide which serve as a catalyst to oxidize the hydrocarbons and carbon monoxide with oxygen to form carbon dioxide and water.

The SCR device 132 may include a reduction catalyst that facilitates conversion of NOx to N2 by a reductant. In some embodiments, the SCR device 132 includes a vanadia catalyst. In other embodiments, the SCR device 132 includes zeolite, base metals, and/or any other suitable type of reduction catalyst. The reductant used to convert NOx to N2 includes, for example, hydrocarbon, ammonia, urea, diesel exhaust fluid (DEF), or any suitable reductant. The reductant may be injected into the exhaust flow path by the reductant delivery device 136 in liquid and/or gaseous form, such as aqueous solutions of urea, ammonia, anhydrous ammonia, or other reductants suitable for SCR operations.

The AMOx catalyst 133 may be any of various flow-through catalysts configured to react with ammonia to produce mainly nitrogen. The AMOx catalyst 133 is structured to remove ammonia that has slipped through or exited the SCR catalyst 132 without reacting with NOx in the exhaust. In certain instances, the exhaust aftertreatment system 150 may be operable with or without an AMOx catalyst. Further, although the AMOx catalyst 133 is shown as a separate unit from the SCR catalyst 132 in FIG. 1, in some implementations, the AMOx catalyst 133 may be integrated with the SCR catalyst 132, e.g., the AMOx catalyst and the SCR catalyst can be located within the same housing.

As discussed above, the SCR system may include a reductant delivery system with a reductant (e.g., DEF) source 134, a pump and a delivery mechanism or doser 136. The reductant source 136 can be a container or tank capable of retaining a reductant, such as, for example, ammonia (NH3), DEF (e.g., urea), or diesel oil. The reductant source 134 is in reductant supplying communication with the pump, which is configured to pump reductant from the reductant source to the delivery mechanism 136 via a reductant delivery line. The delivery mechanism 136 is positioned upstream of the SCR catalyst 132. The delivery mechanism 136 is selectively controllable, by the controller 130, to inject reductant directly into the exhaust gas stream prior to entering the SCR catalyst 132.

As also shown, a plurality of sensors are included in the exhaust aftertreatment system 150. The sensors may be in communication with the controller 130, such that the controller 130 can monitor and acquire data indicative of operation of the aftertreatment system 150. In this regard, the aftertreatment system 150 includes NOx sensors 12, flow rate sensors 14, temperature sensors 16, and particulate matter sensors 18. The NOx sensors 12 acquire data indicative of or, if virtual, determine a NOx amount at or approximately at their disposed location. The flow rate sensors 14 acquire data indicative of or, if virtual, determine an approximate flow rate of the exhaust gas at or approximately at their disposed location. The temperature sensors 16 acquire data indicative of or, if virtual, determine an approximate temperature of the exhaust gas at or approximately at their disposed location. The particulate matter sensors acquire data indicative of or, if virtual, determine an approximate amount of particulate matter flowing in the exhaust gas at or approximately at their disposed location at a given sampling time. It should be understood that the depicted locations, numbers, and type of sensors is illustrative only. In other embodiments, the sensors may be positioned in other locations, there may be more or less sensors than shown, and/or different/additional sensors may also be included with the aftertreatment system 150 (e.g., a pressure sensor, etc.). Those of ordinary skill in the art will appreciate and recognize the high configurability of the sensors in the aftertreatment system 150.

The operator I/O device 140 may enable an operator of the vehicle 102 (or passenger or manufacturing, service, or maintenance personnel) to communicate with the vehicle 102 and the controller 130. By way of example, the operator I/O device 140 may include, but is not limited to, an interactive display, a touchscreen device, one or more buttons and switches, voice command receivers, and the like. For example, information relating to the data/information acquired by the controller 130 or operations/commands provided by the controller 130 to control or manage one or more components (e.g., engine 110) may be provided to an operator or user via the operator I/O device 140.

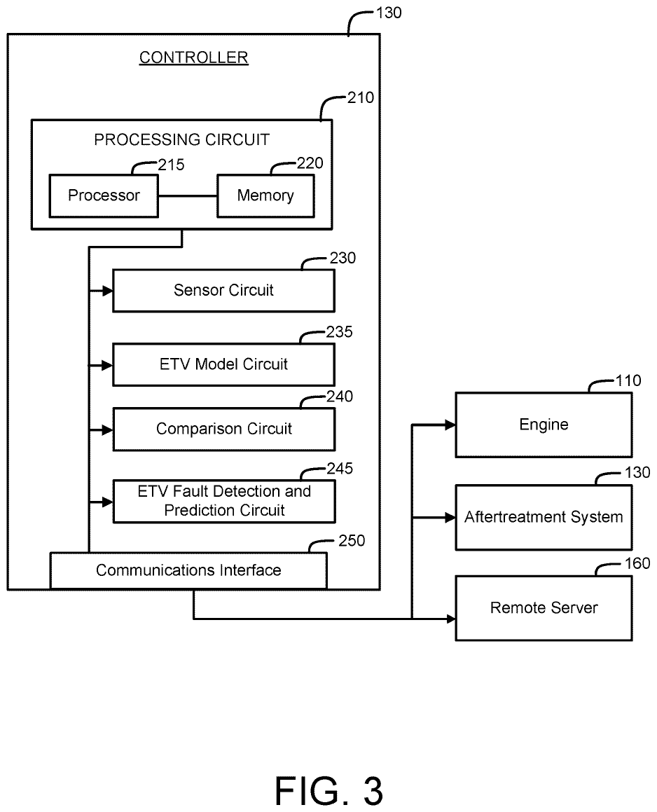

The one or more controllers 130 may be structured as one or more electronic control units (ECU). As such, the controller 130 may be separate from or included with at least one of a transmission control unit, an exhaust aftertreatment control unit, a powertrain control module, an engine control module, etc. The function and structure of the controller 130 is described in greater detail in FIG. 3.

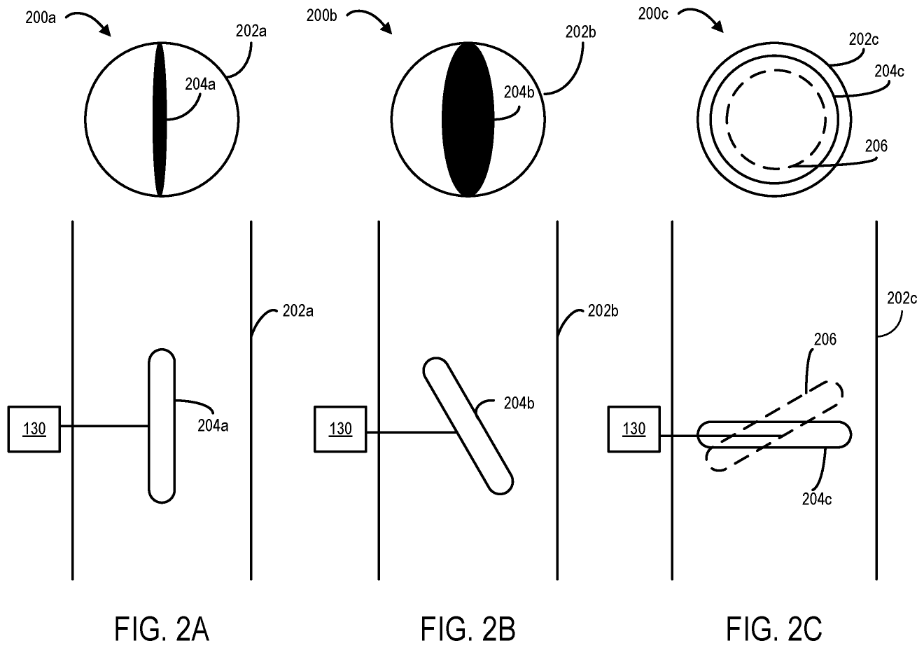

Referring now to FIGS. 2A-2C, ETVs 200a-200c are shown, according to an exemplary embodiment. In some embodiments, the ETVs 200a-200c may be butterfly valves comprising a throttle valve body and an ETV disk. For example, the ETVs 200a-200c may include a throttle bodies 202a-202c and ETV disks 204a-204c (also referred to as valve members or valve elements) respectively. ETV 200a demonstrates an ETV that is in a 100% open position. ETV 200b demonstrates an ETV that is in between a 100% opened position and a 100% closed position (e.g., 60% open position). ETV 200c demonstrates an ETV that is in a fully closed position. While the ETV 200c may be commanded to be in a fully closed position, ETV 200c may have some wear and may have degraded in performance leading to a throttle valve fault (also referred to as a positioned-controlled valve fault). A throttle valve fault refers to when an actual position of a position-controlled valve (e.g., ETV) is different from commanded position of the position-controlled valve. In some embodiments, the controller 130 may be configured to detect and analyze a throttle valve fault within the ETVs 200a-200c. In some embodiments, the throttle valve fault may be defined by the percentage difference between one or more predetermined threshold parameters which describe a commanded ETV disk position 204c and one or more current operational parameters which describe an actual ETV disk position 206. In some embodiments, a certain threshold of difference between the predetermined threshold parameters and the current operational parameters (e.g., margin of error) over a plurality of qualified events may be considered allowable before the controller 130 detects/determines a throttle valve fault. In some embodiments, the margin of error may be defined as a percentage (e.g., +/−10%). Position-controlled valve faults may cause multiple progressive faults within the engine 110 and the aftertreatment system 150. For example, an exhaust throttle valve fault (e.g., the actual ETV disk position 206 is not fully closed) may lead to decreased temperatures in the aftertreatment system which may lead to decreased NOx conversion efficiency and other adverse effects. Therefore, systems and methods for detecting and predicting a health of an air handling valve with position sensing (i.e., predicting position-controlled valve faults) are desired. In some embodiments, the controller 130 may be configured to determine this margin of error and detect or determine a throttle valve fault based on a trend of a decreasing amount of margin of error between the commanded ETV disk position 204c and the actual position 206 to predict a throttle valve fault. The controller 130 is described in more detail below with respect to FIG. 3.

Referring now to FIG. 3, a block diagram of the controller 130 of the position-controlled valve fault prediction system 100 is shown, according to an exemplary embodiment. The controller 130 may be coupled to various vehicle components, such as the engine 110, the aftertreatment system 150, and the ETV. The controller 130 may also be coupled to the remote server 160 through network 155. In some embodiments, the controller 130 is coupled to and controls the operation of one or more components of the vehicle 102 (e.g., engine 110 and the aftertreatment system 150).

The controller 130 includes a processing circuit 210 having a processor 215 and a memory 220. The controller 130 also includes a sensor circuit 230, an ETV model circuit 235, a comparison circuit 240, a fault detection and prediction circuit 245, and a communications interface 250. The controller 130 is determine this margin of error and detect a throttle valve fault or a trend of a decreasing amount of margin of error between the predetermined threshold parameters and the current operational parameters of the ETV to predict a throttle valve fault. By predicting position-controlled valve faults before the faults happen, the controller 130 may initiate one or more actions or control the operation of one or more components of the vehicle 102 (e.g., the compressor 112, the turbine 124, the wastegate 126, the aftertreatment system 150, etc.) to prevent a throttle valve fault from occurring or to resolve the ETV fault.

In one configuration, the sensor circuit 230, the ETV model circuit 235, the comparison circuit 240, and the fault detection and prediction circuit 245 are embodied as machine or computer-readable media that stores instructions and that is executable by a processor, such as processor 215. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the sensor circuit 230, the ETV model circuit 235, the comparison circuit 240, and the fault detection and prediction circuit 245 are embodied as hardware units such as electronic control units. In another configuration, the sensor circuit 230, the ETV model circuit 235, the comparison circuit 240, and the fault detection and prediction circuit 245 may be embodied as one or more circuitry components including, but not limited to, processing circuitry, network interfaces, peripheral devices, input devices, output devices, sensors, etc. In some embodiments, the sensor circuit 230, the ETV model circuit 235, the comparison circuit 240, and the fault detection and prediction circuit 245 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the sensor circuit 230, the ETV model circuit 235, the comparison circuit 240, and the fault detection and prediction circuit 245 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The sensor circuit 230, the ETV model circuit 235, the comparison circuit 240, and the fault detection and prediction circuit 245 may also include programmable hardware devices such as field programmable gate arrays, programmable array logic, programmable logic devices or the like. The sensor circuit 230, the ETV model circuit 235, the comparison circuit 240, and the fault detection and prediction circuit 245 may include one or more memory devices for storing instructions that executable by the processor(s) of the sensor circuit 230, the ETV model circuit 235, the comparison circuit 240, and the fault detection and prediction circuit 245. The one or more memory devices and processor(s) may have the same or similar definition as provided below with respect to the memory 220 and processor 215. In some hardware unit configurations, the sensor circuit 230, the ETV model circuit 235, the comparison circuit 240, and the fault detection and prediction circuit 245 may be geographically dispersed throughout separate locations in the position-controlled valve fault prediction system 100. Alternatively and as shown, the sensor circuit 230, the ETV model circuit 235, the comparison circuit 240, and the fault detection and prediction circuit 245 may be embodied in or within a single unit/housing, which is shown as the controller 130.

In the example shown, the controller 130 includes the processing circuit 210 having the processor 215 and the memory 220. The processing circuit 210 may be structured or configured to execute or implement the instructions, commands, and/or control processes described herein with respect to the sensor circuit 230, the ETV model circuit 235, the comparison circuit 240, and the fault detection and prediction circuit 245. The depicted configuration represents the sensor circuit 230, the ETV model circuit 235, the comparison circuit 240, and the fault detection and prediction circuit 245 as instructions stored in non-transitory machine or computer-readable media. However, as mentioned above, this illustration is not meant to be limiting as the present disclosure contemplates other embodiments the sensor circuit 230, the ETV model circuit 235, the comparison circuit 240, and the fault detection and prediction circuit 245, or at least one circuit of the sensor circuit 230, the ETV model circuit 235, the comparison circuit 240, and the fault detection and prediction circuit 245, is configured as a hardware unit. All such combinations and variations are intended to fall within the scope of the present disclosure.

The processor 215 may be one or more of a group of processors, a single- or multi-chip processor, a digital signal processor (DSP), an application specific integrated circuit (ASIC), a field programmable gate array (FPGA), or other programmable logic device, discrete gate or transistor logic, discrete hardware components, another type of suitable processor, or any combination thereof designed to perform the functions described herein. In this way, the processor 215 may be a microprocessor, a state machine, or other suitable processor. The processor 215 also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the sensor circuit 230, the ETV model circuit 235, the comparison circuit 240, and the fault detection and prediction circuit 245 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory 220 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 220 may be communicably coupled to the processor 215 to provide computer code or instructions to the processor 215 for executing at least some of the processes described herein. Moreover, the memory 220 may be or include tangible, non-transient volatile memory or non-volatile memory. Accordingly, the memory 220 may include database components, object code components, script components, or any other type of information structure for supporting the various activities and information structures described herein.

The communications interface 250 may include any combination of wired and/or wireless interfaces (e.g., jacks, antennas, transmitters, receivers, transceivers, wire terminals) for conducting data communications with various systems, devices, or networks structured to enable in-system communications (e.g., between and among the components of the position-controlled valve fault prediction system 100) and out-of-vehicle communications (e.g., with a remote server and/or cloud). For example and regarding out-of-vehicle/system communications, the communications interface 250 may include an Ethernet card and port for sending and receiving data via an Ethernet-based communications network and/or a Wi-Fi transceiver for communicating via a wireless communications network. The communications interface 250 may be structured to communicate via local area networks or wide area networks (e.g., the Internet) and may use a variety of communications protocols (e.g., IP, LON, Bluetooth, ZigBee, radio, cellular, near field communication).

The communications interface 250 may facilitate communication between and among the controller 130 and one or more components of the vehicle 102 (e.g., the engine 110, the aftertreatment system 150, the sensors etc.). Communication between and among the controller 130 and the components of the vehicle 102 may be via any number of wired or wireless connections (e.g., any standard under IEEE). For example, a wired connection may include a serial cable, a fiber optic cable, a CAT5 cable, or any other form of wired connection. In one embodiment, a controller area network (CAN) bus provides the exchange of signals, information, and/or data. The CAN bus can include any number of wired and wireless connections that provide the exchange of signals, information, and/or data. The CAN bus may include a local area network (LAN), or a wide area network (WAN).

The sensor circuit 230 is structured to communicate with the aftertreatment sensors (e.g., any of sensors 12-18) and any other sensors included in the position-controlled valve fault prediction system 100 (e.g., battery voltage sensors) via the communication interface 250 to receive sensor data that may be used to predict and determine a health of the air handling valve, such as position-controlled valve faults. For example, the sensor circuit 230 is structured to receive a position signal of an ETV disk from the ETV position sensor 125. In this case, the ETV position sensor 112 may include a Hall effect sensor, a linear variable differential transformer, proximity sensors, or any other type of position sensor which is configured to determine the position of the ETV disk. As another example, the sensor circuit 230 is structured to receive an aftertreatment temperature signal from the sensors 16 or an exhaust gas flow rate signal from the sensors 14. The sensor circuit 230 is configured to provide the sensed data to the ETV model circuit 235 and the fault detection and prediction circuit 245. The ETV model circuit 235 may then use the sensed data to retrieve a position-controlled valve fault prediction model (i.e., a health prediction model) which may be used to predict a health, such as faults and particularly position-controlled valve faults of the air handling valve. The fault detection and prediction circuit may use the sensed data to detect or predict a position-controlled valve fault.

The ETV model circuit 235 is structured to retrieve one or more ETV models that may be used to predict position-controlled valve faults. In some embodiments, the ETV models may utilize sensor data received from the sensor circuit 230 and/or one or more operational metrics (e.g., speed of the engine, temperature of the engine, etc.) regarding the vehicle 102. The operational metrics may include data of other not shown components, such as electrical data (e.g., a battery voltage for the vehicle 102, a battery current for the vehicle 102, etc.). In some embodiments, the ETV model may be a machine learning model (e.g., a neural network, random forest, a support vector machine, etc.). In some embodiments, the ETV model of the exhaust throttle valve is a second order electro-mechanical model. The electro-mechanical model utilizes a voltage-balance on the electrical side and a torque balance on the mechanical side as a plant model for the ETV. Hence, the electrical and mechanical balances together form an “electro-mechanical model.” The electro-mechanical method may be summarized in Equation (1) and Equation (2) below:

$${v}_{b} * u = {a}_{1} * y + {a}_{2} * \dot{y} + {a}_{3} * \ddot{y} + {a}_{4} * {y}^{2} \qquad ( 1 )$$

$$\int \int ( {v}_{b} * u ) dt = {a}_{1} * \int \int y dt + {a}_{3} * y + {a}_{4} \int \int {y}^{2} dt \qquad ( 2 )$$

where a₁, a₂, a₃, and a₄ represent control operational parameters of the position-controlled valve (e.g., ETV).

In Equations (1) and (2), u is a PWM duty cycle in fraction (varies between −1 to 1), y is the ETV position in percent, and v_{b} is the battery voltage supplied/utilized. The ETV models, or model structure, may be used by the controller 130 to determine one or more predetermined threshold or reference parameters regarding the ETV which may be stored in the memory of the controller 130 (or remotely). Equations (1) and (2) may be utilized during auto-zero or auto-closure qualified events. When these events occur, the engine is stopped so the pressure drop across the valve is zero or approximately zero. However, during certain qualified events, a pressure differential may be experienced (i.e., the engine is running causing exhaust gas to flow through the ETV thereby leading to a pressure drop across the ETV). In these qualified event situations, different equations that account for this occurrence may be utilized. Equations (3) and (4) represent these types of qualified events being account for by the inclusion of the differential pressure term along with an additional operational parameter (a5).

$${v}_{b} * u = {a}_{1} * y + {a}_{2} * \dot{y} + {a}_{3} * \ddot{y} + {a}_{4} * {y}^{2} + {a}_{5} Δ P \qquad ( 3 )$$

$$\int \int ( {v}_{b} * u ) dt = {a}_{1} * \int \int ydt + {a}_{3} * y + {a}_{4} \int \int {y}^{2} dt + {a}_{5} \int \int Δ P dt \qquad ( 4 )$$

The differential pressure, ΔP, may be determined by upstream and downstream pressure sensors of the valve that are used by the controller to determine a pressure drop across the valve (i.e., upstream pressure reading minus downstream pressure reading). In other embodiments, different ways to determine a pressure drop across the valve may be used.

In either situation (whether the differential pressure term is used or not), the ETV models may be used to dynamically determine current operational parameters for the ETV based on observed behavior of the ETV. In particular, with given u, v_{b}, and y, experimental data may be used to determine “good” or “healthy” parameters and “failed” or “unhealthy” parameters which may be stored in the controller as predetermined or reference parameters, a₁, a₂, a₃, and a₄, which represent the “predetermined threshold parameters”. An a5 reference parameter may be used in situations where the qualified event includes expected pressure differentials across the valve (i.e., during transient operation).

The operational parameters are indicative of/represent characteristics of the position-controlled valve and, particularly, physical characteristics of the position controlled valve. The parameters, a₁, a₂, a₃, and a₄ (and a₅, in some embodiments), may represent individual characteristics of the valve (e.g., a1 may represent the torque constant) and/or a combination of characteristics of the valve (e.g., a1 may represent the torque constant relative to the spring constant). Thus, the operational parameters may include, but are not limited to, a torque constant of the motor, a resistance of the armature, a spring coefficient, a back EMF coefficient, an inertia of the valve, and/or other physical characteristics of the position-controlled valve. In one embodiment, the control operational parameters (or, operational parameters), a₁, a₂, a₃, and a₄, represent a back EMF constant (a1), a spring constant (a2), a torque constant (a3), and an inertia of the valve (or ratios of one or more of these values to each other) (a4). In another embodiment, the operational parameters, a₁, a₂, a₃, and a₄, represent a ratio of a resistance across the valve to a spring constant for the valve (a1), a back EMF constant (a2), a ratio of an inertia of the valve relative to a spring constant (a3), and a ratio of a spring constant to the torque constant (a4). In yet another embodiment, the control parameters represent the back EMF constant (a1), the torque constant (a2), the spring constant (a3), and a resistance across the valve (a4) (or, more particularly, a resistance of an armature of the valve). In yet another embodiment, the control parameters represent the inertia across the valve (a1), the torque constant (a2), the spring constant (a3), and a ratio of the torque constant to a product of the spring constant and another constant (a4). In this way and as alluded to above, the control parameters may relate different parameters to each other to form any one or more of a₁, a₂, a₃, and a₄ (and, a5, in some embodiments). In some other embodiments and as indicated above, a₁, a₂, a₃, and/or a₄ may be a singular value (e.g., a1 is the back EMF constant and a2 is the spring constant while a3 relates the torque constant to the spring constant and a4 relates the inertia to the torque constant). In still other embodiments, more or less than four control operational parameters may be used. In still further embodiments, additional, less, or different parameters may be used (e.g., relative to the back EMF constant, inertia, torque constant, resistance, spring constant, etc.).

During operation of the ETV (or other position-controlled valve), the controller may determine current a₁, a₂, a₃, and a₄, which represent the “current operational parameters” regarding the ETV using a particular process, such as recursive least squares. In some embodiments, the ETV models and the parameters determined based on the ETV models may be stored in the memory 220. In other embodiments, the controller 130 may transmit sensed or determined information to the remote server 160 for processing and diagnosis. Based on the determined operational parameters, the ETV model may predict a future operation of the ETV (e.g., an amount predicted to be closed or open for a given voltage and PWM signal).

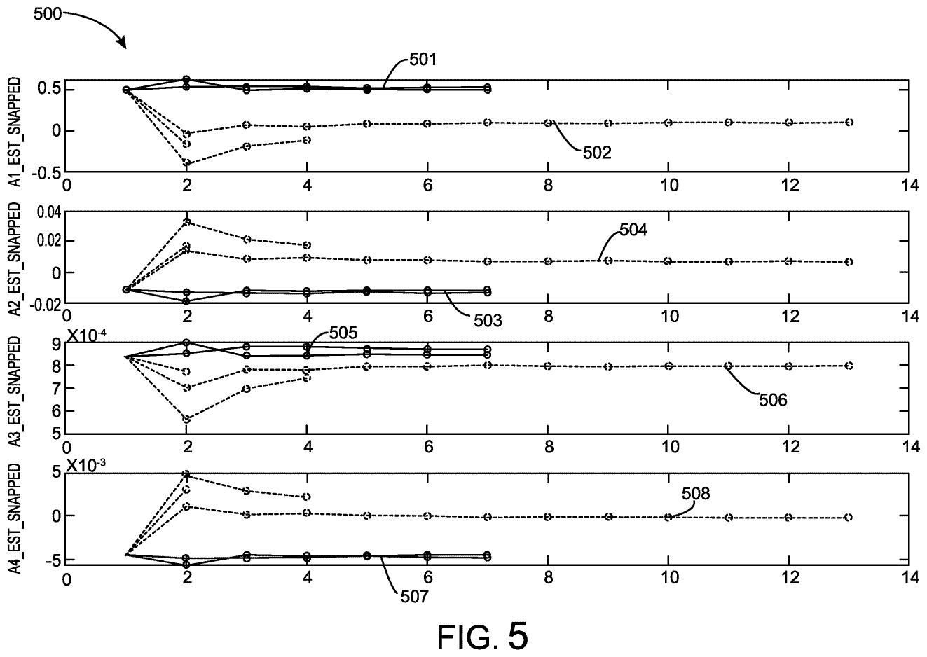

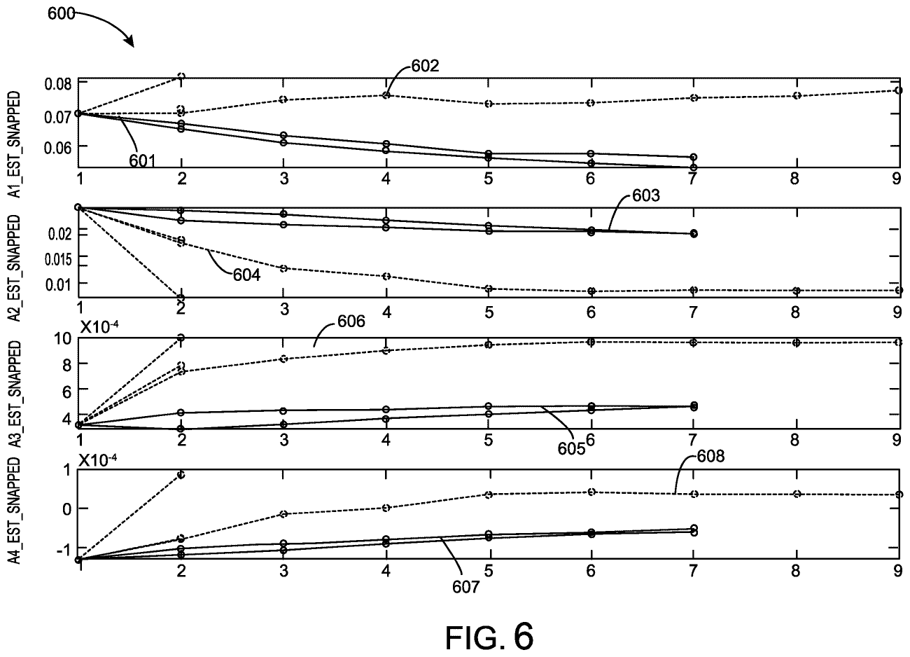

The comparison circuit 230 is structured to communicate with the ETV model circuit 235 to compare the current operational parameters from the ETV model circuit 235 to one or more predetermined threshold or reference parameters stored in the memory 220 (e.g., a threshold for each of a₁, a₂, a₃, and a₄). For example, referring now to FIGS. 5 and 6, a first comparison graph 500 and a second comparison graph 600 are shown. In the set of graphs 500, predetermined unhealthy/failed threshold parameters 502, 504, 506, and 508 and predetermined healthy/non-failed threshold parameters 501, 503, 505, and 507 are shown based on Equation (1) recited above. On the y-axis, the numerical values for the predetermined healthy threshold parameters and the predetermined unhealthy threshold parameters are shown. On the x-axis, corresponding successive qualified events, such as a closure events, are shown. Comparison graph 600 determines the predetermined unhealthy/failed threshold parameters 602, 604, 606, and 608 and predetermined healthy/non-failed threshold parameters 601, 603, 605, and 607 based on Equation (2) recited above. On the y-axis, the numerical values for the predetermined healthy threshold parameters and the predetermined unhealthy threshold parameters are shown. On the x-axis, corresponding successive qualified events, such as closure events, is shown.

The comparison circuit 230 may be configured to determine (i.e., calculate) the difference between the current operational parameters and the predetermined healthy and unhealthy threshold parameters to determine a margin of error between the predetermined threshold parameters and the current operational parameters (i.e., using one or more of the graphs 500 and 600; i.e., chart the current determined operation parameters on one or more of the graphs 500 and 600 to determine whether the current operation parameters are closer to healthy or unhealthy valves). In some embodiments, the predetermined healthy and unhealthy threshold parameters may be indicative of a maximum allowable difference value (e.g., in percentage) between a commanded ETV position and the actual ETV position. The predetermined healthy and unhealthy threshold parameters may be based on lab or experimental data regarding various system arrangements and communicated from the remote server 160 to the controller 130 regarding operation of healthy air handling valves and unhealthy or failed air handling valves (e.g., parameters for healthy air handling valves when commanded to certain positions, etc.). In some embodiments, the predetermined healthy and unhealthy thresholds may be defined by an operator or other user. The comparison circuit 108 is structured to determine an offset or a differential based on the predetermined threshold.

The fault detection and prediction circuit 245 is structured to detect or determine a valve fault based on a determined trend regarding a margin of error of the predetermined threshold parameters and the current operational parameters through a plurality of (in one embodiment, successive) ETV operations/qualified events and, particularly, auto zero offset determination operations. More specifically, the fault detection and prediction circuit 245 receives the sensor data from sensor circuit 230 and a commanded position of the ETV (e.g., in the form of a voltage). The fault detection and prediction circuit 245 may then apply the sensor data and commanded position of the ETV as an input to the ETV model to determine a predicted operation of the ETV (e.g., a recursive least squares process). A plurality of the predicted operations of the ETV may then be evaluated by the fault detection and prediction circuit 245 to determine a trend, which can be extrapolated to determine potential future operations (e.g., future closure commands), to ultimately predict future position-controlled valve faults. In some embodiments, the determined trend is indicative of an amount of a margin of error between the predetermined threshold parameters and the current operational parameters as determined by the ETV model.

The margin of error refers to the difference or value (measured or estimated) between the predetermined threshold or reference parameters and the current operational parameters. In one embodiment, a margin of error may be determined for each of a plurality of successive qualified events (e.g., ETV position controlled events, auto closure events, etc.) to predict or otherwise determine a trend regarding the margin of error throughout the operation of a position-controlled valve such as an ETV.

In one embodiment, the margin of error trend may be used to predict or otherwise determine a position-controlled valve fault before it occurs or happens. For example, if the margin of error trend for each successive predicted ETV position-controlled event is moving closer to the predefined unhealthy reference parameters over a predefined number of qualified events, the controller may determine an unhealthy valve and flag/trigger a position-controlled valve fault. As another example, if the margin of error trend for each successive predicted ETV position-controlled event is moving closer to the predefined healthy reference parameters over a predefined number of qualified events (e.g., 5, 10, 20, etc.), the controller may determine no or likely no position-controlled valve fault (i.e., a healthy valve actuator).

In another embodiment, the rate at which the margin of error for each successive qualified events increases or decreases may be indicative of a failure of the ETV. For example, a rapidly increasing margin of error between successive predicted ETV position controlled events (e.g., 50% increase of margin of error between successive predicted ETV position controlled events) may indicate a physical fault within the ETV (e.g., the ETV being broken) while a modestly increasing margin of error between successive predicted ETV position controlled events (e.g., 5% loss of margin of error between successive predicted ETV position controlled events) may indicate an position-controlled valve fault.

In some embodiments, only one of the estimated operation parameters (e.g., determine a1 or a2, etc.) relative to the predetermined healthy or unhealthy parameters may be used to predict or determine a position controlled fault. Further, either one of the charts 500 or 600 may then be used to perform the comparison. In other embodiments, at least one of the estimated parameters is used in the comparison relative to the predetermined healthy or unhealthy parameters (e.g., a1 and a2; a1, a2, and a4; a1-a4; a1-a5; etc.). In this latter instance, the controller may determine if the comparison for all or a majority of the estimated parameters is moving towards (margin of error) the healthy or unhealthy reference parameters for each associated determined operating parameter to determine/trigger a fault (e.g., a fault code, a malfunction indicator lamp, etc.) for the position-controlled valve.

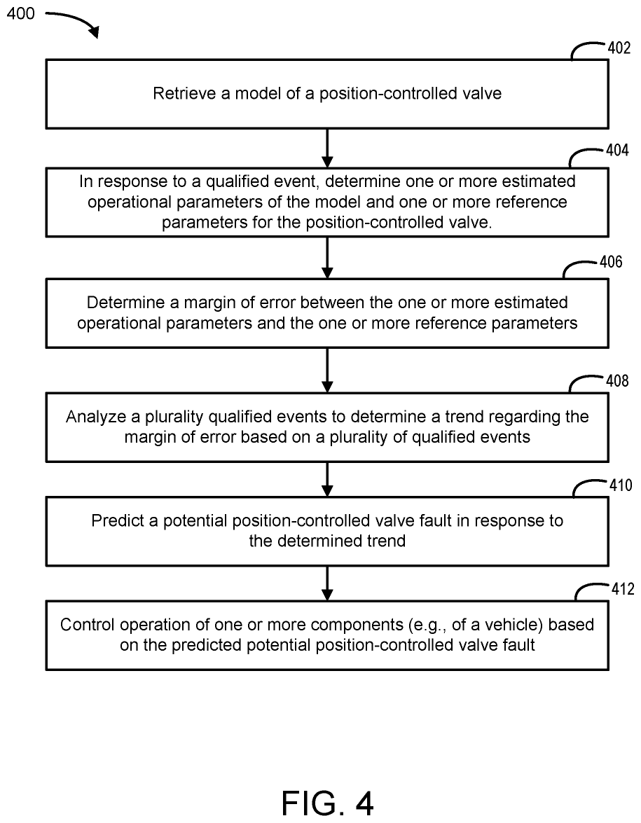

Referring now to FIG. 4, a process 400 for detecting and predicting a health of an air handling valve is shown, according to an exemplary embodiment. In particular, process 400 depicts a process for detecting and predicting position controlled valve faults for an air handling valve, according to an example embodiment. Process 400 may be implemented by the controller 130. As described above, the process 400 analyzes successive qualified events (e.g., opening the ETV disk/valve member, closing the ETV disk, determining an auto zero offset, etc.) to determine a trend of the amount of margin of error between a commanded ETV disk position and an actual ETV disk position to predict position controlled valve faults. It will be appreciated that certain steps of process 400 may be optional and, in some embodiments, process 400 may be implemented using less than all of the steps.

At step 402, the controller 130 retrieves a model describing the behavior or an air handling valve actuator such as an ETV. In some embodiments, the model may be a second order electro-mechanical model as described above. The model may be configured to determine one or more estimated operational parameters of the ETV. More specifically, based on the sensor data, the model may predict a future operation of the ETV based on the model.

At step 404, the controller 130 determines or receives an indication if qualified event has occurred. In response to the qualified event occurring, the controller 130 determines or receives one or more predetermined threshold parameters (e.g., heathy threshold parameters and unhealthy threshold parameters) and determines one or more estimated operational parameters based on the model for the position-controlled valve. The qualified event may be commanded by the controller 130 based on an operator input, pursuant to a diagnostic process, and/or via another methodology. In response to determining that a qualified event has occurred, the controller 130 determines one or more estimated operational parameters for the position-controlled valve based on the model retrieved in step 402. More specifically, the controller 130 applies the sensor data and commanded position of the ETV as an input to the ETV model to determine one or more estimated operational parameters, a₁, a₂, a₃, and a₄ of the ETV (and, in some embodiments, a5). The controller may also determine one or more predetermined threshold parameters a₁, a₂, a₃, and a₄. The threshold parameters may be the healthy threshold parameters and/or unhealthy threshold parameters described in FIG. 5 and FIG. 6.

At step 406, the controller 130 determines or receives a margin of error between the predetermined reference parameters and the estimated operational parameters to determine an actual margin of error for each qualified event. In one implementation, the predetermined reference parameters and the estimated operational parameters may be sent and stored on the remote server 160. The remote server 160 may then determine a margin of error between the predetermined reference parameters and the estimated operational parameters. In such a case, the controller 130 may receive the margin of error that is transmitted from the remote server 160 (e.g., over the network). This may reduce on-board computing requirements. The controller 130 may determine the margin of error by finding or otherwise determining the difference between the predetermined reference parameters and the estimated operational parameters.

At step 408, the controller 130 analyzes a plurality of qualified events, such as ETV closure events, to determine a trend regarding the margin of error based on the plurality of qualified events. In some embodiments, the remote server 160 may analyze a plurality of qualified events, such as ETV closure events, to determine a trend regarding the margin of error based on the plurality of qualified events instead of the controller 130. In such a case, the controller 130 may receive a trend regarding the margin of error from the remote server 160 (e.g., over a network). In some embodiments, the plurality of qualified events may be successive position controlled events. For example, the margin of error between successive predicted ETV position controlled events may be measured, estimated, or otherwise determined to determine a trend regarding the amount of margin of error for each event for a plurality of events. For example, the margin of error may be +/−10%. After a first qualified event, there may be no difference between the predetermined threshold parameters and the current operational parameters leaving the full amount of margin of error left (e.g., the full 10%). After a second predicted successive qualified event, there may be a slight difference between the predetermined threshold parameters and the current operational parameters leaving 9% of the margin of error left. After a third predicted successive qualified event, there may be a larger difference between the predetermined threshold parameters and the current operational parameters leaving 1% of the margin of error left. In this case, the controller 130 determines a trend of decreasing amounts of margin of error remaining relative to predetermined healthy or unhealthy parameters. If the trend is moving towards the unhealthy parameters, at step 410, the controller 130 predicts or determines a potential position-controlled valve fault (i.e., unhealthy). If the trend is moving towards the healthy parameters, the controller 130 may determine that the air handling valve is healthy.

At step 412, the controller 130 controls operation of one or more components of the vehicle 102 based on the predicted position-controlled valve fault. More specifically, the controller 104 may control operation of the engine 110, the aftertreatment system 150, and/or the ETV 128 based on a predicted position-controlled valve fault. For example, the controller 130 may increase the frequency of the pulse width modulation signal used open and/or close the ETV 128 in response to the predicted position-controlled valve fault. For example, if a fault is triggered, the controller 130 may command the ETV to a relatively more close position (e.g., eighty percent closed relative to typically sixty percent close) to ensure or attempt to ensure that flow of the exhaust gas is restricted as desired in order to maintain temperatures within the exhaust aftertreatment system as desired (e.g., a desired temperature for the SCR that is associated with a desired NOx conversion efficiency). As another example, the controller 130 may communicate a message to a user through the communications interface 250 that the vehicle 102 needs maintenance to address the position-controlled valve fault in response to the predicted position-controlled valve fault. In some embodiments, the process 400 may be implemented on any number of valve therefore, the controller 130 may track parameters from the valves and calibrate the valves based on the tracked parameters.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2 it should be understood that the controller 130 may include any number of circuits for completing the functions described herein. For example, the activities and functionalities of various circuits may be combined in multiple circuits or as a single circuit. Additional circuits with additional functionality may also be included. Further, the controller 130 may control other activity beyond what is described herein.

As mentioned above and in one configuration, the “circuits” may be implemented in machine-readable medium for execution by various types of processors, such as the processor of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system comprising:
a position-controlled valve; and
at least one processing circuit coupled to the position-controlled valve, the at least one processing circuit configured to:
determine one or more estimated operational parameters for the position-controlled valve based on a model;
retrieve one or more reference parameters for the position-controlled valve;
determine a margin of error between the one or more estimated operational parameters and the one or more reference parameters;
determine a trend regarding the margin of error;
predict a fault in response to the trend regarding the margin of error; and
control operation of the position-controlled valve in response to predicting the fault.

2. The system of claim 1, wherein the position-controlled valve is an exhaust throttle valve.

3. The system of claim 1, wherein the model is a second order electro-mechanical model.

4. The system of claim 1, wherein controlling the operation of the position-controlled valve includes increasing a frequency of selectively opening or closing, at least partially, the position-controlled valve.

5. The system of claim 1, wherein controlling the operation of the position-controlled valve includes generating and providing a message regarding the position-controlled valve.

6. The system of claim 1, wherein the at least one processing circuit is further configured to:
determine that a qualified event has occurred; and
in response to determining that the qualified event has occurred, retrieve the one or more reference parameters for the position-controlled valve.

7. The system of claim 6, wherein the qualified event is at least one of opening the position-controlled valve, closing the position-controlled valve, or determining an auto zero offset.

8. A method for controlling a position-controlled valve, the method comprising:
receiving, by a controller, one or more estimated operational parameters for the position-controlled valve based on a model;
retrieving, by the controller, one or more reference parameters for the position-controlled valve;
receiving, by the controller, a margin of error between the one or more estimated operational parameters and the one or more reference parameters;
receiving, by the controller, a trend regarding the margin of error;
predicting, by the controller, a fault in response to the trend regarding the margin of error; and
controlling, by the controller, operation of the position-controlled valve in response to predicting the fault.

9. The method of claim 8, wherein the position-controlled valve is an exhaust throttle valve.

10. The method of claim 8, wherein the model is a second order electro-mechanical model.

11. The method of claim 8, wherein controlling the operation of the position-controlled valve includes increasing a frequency of opening or closing, at least partially, the position-controlled valve.

12. The method of claim 8, wherein controlling the operation of the position-controlled valve includes generating and providing a message regarding the position-controlled valve.

13. The method of claim 8, further comprising:
determining that the trend regarding the margin of error indicates an increasing margin of error; and
determining the fault associated with the position-controlled valve.

14. The method of claim 8, further comprising:
determining that the trend regarding the margin of error indicates a steady or decreasing margin of error; and
determining no fault associated with the position-controlled valve.

15. A non-transitory computer-readable media storing instructions therein that, when executed by at least one processor, causes the at least one processor to perform operations comprising:
determining one or more estimated operational parameters for a position-controlled valve based on a model;
retrieving one or more reference parameters for the position-controlled valve;
determining a margin of error between the one or more estimated operational parameters and the one or more reference parameters;
determining a trend regarding the margin of error;
predicting a fault in response to the trend regarding the margin of error; and
controlling operation of the position-controlled valve in response to predicting the fault.

16. The computer-readable media of claim 15, wherein the position-controlled valve is an exhaust throttle valve.

17. The computer-readable media of claim 15, wherein the model is a second order electro-mechanical model.

18. The computer-readable media of claim 15, wherein controlling the operation of the position-controlled valve includes increasing a frequency of opening or closing, at least partially, the position-controlled valve.

19. The computer-readable media of claim 15, wherein controlling the operation of the position-controlled valve includes generating and providing a message regarding the position-controlled valve.

20. The computer-readable media of claim 15, wherein the reference parameter is one of a healthy reference parameter or an unhealthy reference parameter, wherein surpassing the healthy reference parameter indicates a healthy position-controlled valve and surpassing the unhealthy reference parameter indicates a faulty position-controlled valve.
